(19) United States
(12) Patent Application Publication
(10) Pub. No.: US 2025/0337030 A1
(43) Pub. Date: Oct. 30, 2025

(54) Robotic Thermal Runaway Gas Sensing Platform For Battery Energy Storage Systems

(71) Applicants: THE REGENTS OF THE UNIVERSITY OF MICHIGAN, ANN ARBOR, MI (US); AMPHENOL ADVANCED SENSORS, St. Marys, PA (US); Universitat Politecnica de Valencia, Valencia (ES)

(72) Inventors: Anna Stefanopoulou, ANN ARBOR, MI (US); Jason Siegel, ANN ARBOR, MI (US); Xin Hui Ooi, ANN ARBOR, MI (US); Vivian Tran, ANN ARBOR, MI (US); Brian Engle, St. Marys, PA (US); Carlos Mico Reche, Valencia (ES); Antonio Garcia Martinez, Valencia (ES)

(21) Appl. No.: 19/194,907

(22) Filed: Apr. 30, 2025

Related U.S. Application Data
(60) Provisional application No. 63/640,345, filed on Apr. 30, 2024.

(51) Int. Cl. H01M 10/48; H01M 10/42; H01M 50/209; H01M 50/258; H01M 50/383

(52) U.S. Cl. CPC H01M 10/482; H01M 10/425; H01M 50/209; H01M 50/258; H01M 50/383; H01M 2010/4271; H01M 10/486

(57) ABSTRACT

A battery energy storage system comprises: (i) a structure dimensioned to receive one or more battery modules, each battery module including one or more battery cells; (ii) an off-gas detector configured to obtain air samples adjacent at least one of the battery cells and to generate signals indicating whether off-gas is detected in each of the air samples, wherein the off-gas detector is mounted on a support of a motion system; and (iii) a controller in electrical communication with the off-gas detector and the motion system, the controller being configured to execute a program stored in the controller to: (i) move the off-gas detector adjacent the at least one of the battery cells, and (ii) receive the signals from the off-gas detector indicating whether off-gas is detected in each of the air samples.

### CROSS-REFERENCES TO RELATED APPLICATIONS

This application is based on, claims benefit of, and claims priority to U.S. Application No. 63/640,345 filed on Apr. 30, 2024, which is hereby incorporated by reference herein in its entirety for all purposes.

### STATEMENT REGARDING FEDERALLY SPONSORED RESEARCH

Not Applicable.

### FIELD OF THE INVENTION

This invention relates to an active gas sensing system with a robotic platform carrying a comprehensive sensor suite guided to locations adjacent one or more battery cells of a battery module in a battery energy storage system, and to methods for detecting or ruling out a fault in one or more battery cells of a battery module in a battery energy storage system.

### BACKGROUND

A battery energy storage system (BESS) typically includes a plurality of batteries and a bi-directional inverter though which direct current energy storage devices such as batteries may be electrically connected to an alternating current external system, such as a power grid. The BESS may be used to temporarily store energy produced by renewable power sources (e.g., photovoltaic (PV) sources and/or wind turbines). When the BESS is coupled to a PV source or wind turbines that can produce electrical power in excess of the grid requirement (e.g., a PV field on a sunny day or a wind turbine on a windy day), the excess power can be used to charge the BESS batteries. Conversely, when the grid requires power greater than what is provided by the renewable sources, the BESS batteries may be discharged to provide power to the grid.

Some battery energy storage systems use lithium-ion batteries. It has been reported that during cycling of certain lithium-ion batteries, the gases CO₂ and CO are released at the cathode, while the gases C₂H₄, CO, and H₂ are released at the anode. Under certain conditions, such as overcharge, overtemperature, and internal short circuiting, lithium-ion cells may undergo thermal runaway. During thermal runaway studies of certain lithium-ion batteries, it has been shown that CO, CO₂, CH₄, HCN, HF, C₂H₄, and C₂H₆ are released. The mixture of released gases is dependent on the type of lithium-ion battery cells, the test method, and the test equipment used. During thermal runaway, the battery cell also releases a large amount of heat. If the cell is not handled in a timely manner with proper risk assessment and emergency response, an overall battery system may be damaged, or even an explosion and/or a fire may be triggered.

Looking at FIG. 1, it has been proposed to equip a battery energy storage system 10 with a stationary gas sensor 20 located above battery cells 23a to 23l of a battery module 25. The stationary gas sensor 20 can monitor the battery module 25 for the release of a gas that signals the need for fire extinguishing procedures. However, examination of accidents in battery energy storage systems reveals that stationary gas sensors are insufficient for providing the necessary information for risk assessment and emergency response, even if every rack of a battery energy storage system is equipped with a stationary gas sensor.

What is needed therefore is: (i) an improved BESS gas sensing system for providing better information for risk assessment and emergency response, and (ii) improved methods for detecting or ruling out a fault in one or more battery cells of a battery module in a battery energy storage system.

### SUMMARY

The foregoing needs are met by an active gas sensing system according to the present disclosure wherein the gas sensing system includes a robotic platform carrying a comprehensive sensor suite guided to locations adjacent one or more battery cells of a battery module in a battery energy storage system, and methods according to the present disclosure for detecting or ruling out a fault in one or more battery cells of a battery module in a battery energy storage system.

In one aspect, the present disclosure provides a battery energy storage system (BESS) that comprises: (i) a structure dimensioned to receive one or more battery modules, each battery module including one or more battery cells; (ii) an off-gas detector configured to obtain air samples adjacent at least one of the battery cells and to generate signals indicating whether off-gas is detected in each of the air samples, wherein the off-gas detector is mounted on a support of a motion system; and (iii) a controller in electrical communication with the off-gas detector and the motion system, wherein the controller is configured to execute a program stored in the controller to: (i) move the off-gas detector adjacent the at least one of the battery cells, and (ii) receive the signals from the off-gas detector indicating whether off-gas is detected in each of the air samples.

In one embodiment of the battery energy storage system, the structure comprises a container, and the motion system comprises a gantry system mounted to a wall or a frame of the container. In one embodiment of the battery energy storage system, the signals received by the controller are passed to a thermal runaway detection algorithm in the program stored in the controller. In one embodiment of the battery energy storage system, the controller is in electrical communication with one or more additional sensors, each additional sensor sensing a parameter associated with at least one of the battery cells, the additional sensors being selected from temperature sensors, pressure sensors, current sensors, voltage sensors, volume change sensors, and swelling sensors, and sensor signals from the one or more additional sensors are passed to the thermal runaway detection algorithm.

In one embodiment of the battery energy storage system, the off-gas is associated with a failure of the at least one of the battery cells, and the controller executes the program stored in the controller to: (iii) identify a location of the failure. In one embodiment of the battery energy storage system, the off-gas detector includes a gas sensor for detecting an off-gas component selected from CO₂, CO, H₂, volatile organic compounds, and combinations thereof. In one embodiment of the battery energy storage system, the off-gas detector includes an environmental sensor for measuring an environmental reading selected from air temperature, pressure, and humidity, and combinations thereof.

In one embodiment of the battery energy storage system, the system further comprises: a sparker mounted on the support of the motion system, the sparker initiating combustion of the off-gas. In one embodiment of the battery energy storage system, the system further comprises: a fan mounted on the support of the motion system, the fan being configured to dilute the off-gas. In one embodiment of the battery energy storage system, the system further comprises: a cooling device mounted on the support of the motion system, the cooling device being configured to cool down the off-gas.

In one embodiment of the battery energy storage system, the structure comprises a rack for receiving the one or more battery modules, and the controller executes the program stored in the controller to move the off-gas detector above and/or below the rack. In one embodiment of the battery energy storage system, the motion system is an XY motion system, and the controller executes the program stored in the controller to control XY motion of the off-gas detector relative to at least one of the battery modules. In one embodiment of the battery energy storage system, the motion system is an XYZ motion system, and the controller executes the program stored in the controller to control XYZ motion of the off-gas detector relative to at least one of the battery modules.

In one embodiment of the battery energy storage system, the controller executes the program stored in the controller to set one or more adaptive gas detection thresholds that account for environmental conditions. In one embodiment of the battery energy storage system, the controller executes the program stored in the controller to calibrate and validate one or more stationary gas sensors mounted on the structure. In one embodiment of the battery energy storage system, the controller executes the program stored in the controller to: (iii) identify a location of the off-gas detector using signals received from an encoder.

In one embodiment of the battery energy storage system, the system further comprises: a camera mounted on the support of the motion system, the camera providing a real-time view of the at least one of the battery cells.

In one embodiment of the battery energy storage system, the controller is in electrical communication with one or more fiducial tags, each fiducial tag being placed on one of the battery modules, and the controller executes the program stored in the controller to: (iii) identify a location of the off-gas detector using signals received from the one or more fiducial tags.

In one embodiment of the battery energy storage system, the motion system includes a power source, and the controller executes the program stored in the controller to: (iii) return the support of the motion system to a docking position for charging of the power source.

In one embodiment of the battery energy storage system, the controller executes the program stored in the controller to move the off-gas detector adjacent the at least one of the battery cells based on a state of health diagnostic from the at least one of the battery cells. In one embodiment of the battery energy storage system, the controller is in electrical communication with an additional sensor for measuring swelling associated with the at least one of the battery cells; and the controller executes the program stored in the controller to determine the state of health diagnostic of the at least one of the battery cells based on a reading from the additional sensor.

In one embodiment of the battery energy storage system, the controller executes the program stored in the controller to move the off-gas detector adjacent the at least one of the battery cells in a path based on the state of health diagnostic of the at least one of the battery cells. In one embodiment of the battery energy storage system, the controller executes the program stored in the controller to move the off-gas detector adjacent the at least one of the battery cells according to a predetermined time schedule. In one embodiment of the battery energy storage system, the controller executes the program stored in the controller to determine whether off-gas is detected in each of the air samples by inputting the signals from the off-gas detector into a trained machine learning model, the trained machine learning model being trained on a plurality of signals from the off-gas detector.

In one embodiment of the battery energy storage system, the trained machine learning model is further trained on an additional plurality of signals from the off-gas detector, the additional plurality of signals being used to characterize off-gas venting from the at least one of the battery cells and expected temporal volume, momentum, and concentrations of off-gases from thermal runaway of the at least one of the battery cells.

In another aspect, the present disclosure provides a method for detecting or ruling out a fault in one or more battery cells of a battery module in a battery energy storage system. The method comprises: (a) providing an off-gas detector mounted on a support of a motion system, wherein the off-gas detector is configured to obtain air samples adjacent at least one of the battery cells and to generate signals indicating whether off-gas is detected in each of the air samples; (b) moving the off-gas detector adjacent the at least one of the battery cells using the motion system; (c) receiving, in a controller in electrical communication with the off-gas detector, signals from the off-gas detector indicating whether off-gas is detected in each of the air samples; and (d) detecting or ruling out a fault in the at least one of the battery cells based on the signals from the off-gas detector received by the controller.

In one embodiment, the present disclosure provides an active gas sensing system with a robotic platform carrying a comprehensive sensor suite guided to “suspected failure location(s)” in a BESS by advanced state of health (SOH) diagnostics from electrothermal cell/module data and a gas sensing interpretation trained with detailed experiments for high-confidence event localization, estimation of a thermal runaway stage, and prediction of the fault fate. The active gas sensing system leverages multidisciplinary technology including: (i) battery cell diagnostics and path planning from sensor interpretation with one or more internal model principles trained with deep learning techniques, and (ii) combustion science and fluids models, such as global (volume-averaged) gas characterization and temporal gas characterization and commercial sensor evaluation.

The foregoing and other aspects and advantages of the invention will appear from the following description. In the description, reference is made to the accompanying drawings which form a part hereof, and in which there is shown by way of illustration example embodiments of the invention. Such embodiments do not necessarily represent the full scope of the invention, however, and reference is made therefore to the claims and herein for interpreting the scope of the invention.

### BRIEF DESCRIPTION OF DRAWINGS

FIG. 1 is a side view of a prior art battery energy storage system with a stationary gas sensor.

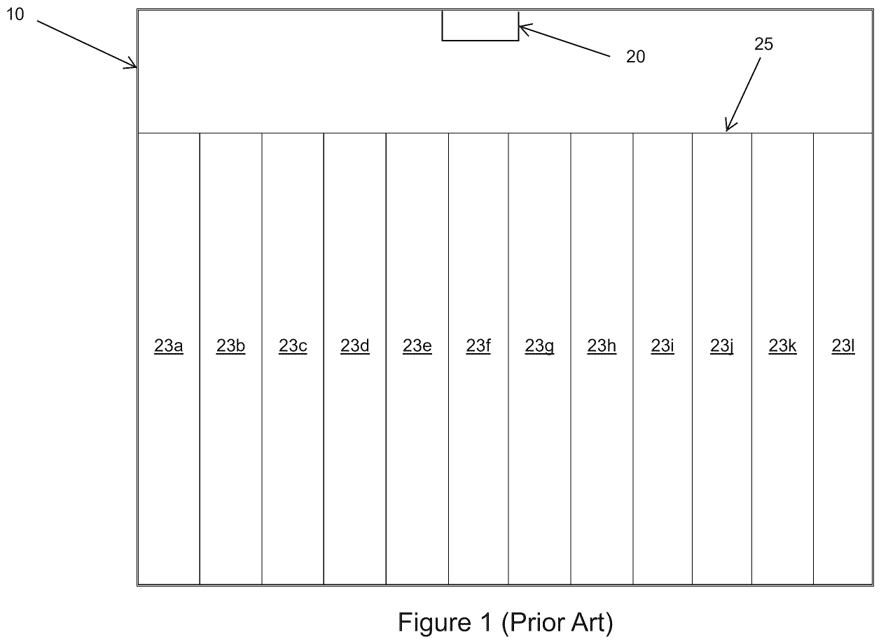

FIG. 2 is a perspective view of a battery energy storage system according to one embodiment of the present disclosure.

FIG. 3 is a side view of a battery module in a rack of the battery energy storage system of FIG. 2.

FIG. 4 is a perspective view of an XYZ motion system of a battery energy storage system according to another embodiment of the present disclosure.

Like reference numerals will be used to refer to like parts from Figure to Figure in the following description of the drawings.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown but are to be accorded the widest scope consistent with the principles and features disclosed herein. Skilled artisans will recognize the examples provided herein have many useful alternatives and fall within the scope of embodiments of the invention.

A robotic battery failure sensing platform is described herein to address issues of undetected flammable and explosive off-gas accumulation in intermediate areas between stationary gas sensors in a battery energy storage system (BESS). The robotic battery failure sensing platform comprises two main parts: a robot having a controller, and a motion system (e.g., a gantry). A robot equipped with sensors to collect environmental data traverses the BESS container on a gantry system mounted to the container walls or frame of the battery racks. The data collected by a controller of the robot is used to inform a robust thermal runaway (TR) detection algorithm that relies on aggregating multiple sensor signals and supplementing stationary data collection, e.g., battery current, voltage, and temperature. During normal operation, the robot will scan and patrol the space inside the container to help monitor the battery modules in the BESS. When a battery failure occurs and vents gasses, the robotic battery failure sensing platform can be used to identify and verify the location of the source of a failure and collect data to evaluate hazards.

The motion system of the battery energy storage system can carry multiple sensors and actuators for TR detection. The sensors can include a suite of commercial gas sensors designed to detect off-gas components, e.g., CO₂, CO, H₂, and volatile organic compounds (VOCs) (including various hydrocarbons and electrolyte components), in addition to measuring environmental air temperature, pressure, and humidity. By scanning the space in the BESS with the motion system, the data from the sensors can be used to build an understanding of the spatial gradients and temporal evolution of gas concentration, temperature, etc., developing in the BESS during a fault. This may also allow fire and deflagration hazards to be identified earlier than with stationary gas sensors due to the large dilution volume in the BESS. The motion system can also carry actuators like sparkers or a fan to preemptively combust or help dilute high concentrations of volatile gasses before serious hazards develop. An auxiliary cooling system can also be used to help cool hot gasses down to the operating temperature range of the onboard gas sensors and ensure continued gas data collection during more advanced stages of a BESS failure. The robot can also be operated remotely to evaluate environmental hazards, for example, off-gas toxicity, before firefighters attempt to breach the container door.

The motion system of the BESS can be customized to accommodate the design of the BESS and target regions where vent gasses are likely to accumulate. This includes extending below and above the battery module racks to measure gas concentrations of heavy (e.g., hydrocarbons and electrolyte vapor) and light (e.g., H₂) species that accumulate there, respectively. As an example of a motion system, i.e., a gantry system, the robot controller can be mounted on a vertical pole to travel up and down the racks while the pole slides left and right along rails mounted to the top and bottom of either the battery module racks of the BESS or the BESS container walls. Similarly, the robot controller can be mounted on a horizontal pole while the pole slides up and down railings mounted on the left-most and right-most edges of the BESS racks or BESS container walls. The gantry design can also be extended to traverse the BESS in the third dimension.

The robotic battery failure sensing platform can also provide additional support during normal operation and maintenance. The onboard sensors can be used to set adaptive gas detection thresholds in the controller that account for environmental conditions. Additionally, the sensors on the motion system of the BESS can be used to help calibrate and validate stationary gas sensors during routine maintenance to combat issues with long-term sensor drift. The robot can be battery-powered and set to dock and charge (e.g., magnetic wireless charging) when the battery state-of-charge of the robot is below a set threshold. The robot can localize itself by going to a set homing position at one of the corners of the BESS. Using an inertial measurement unit (IMU) sensor or encoders, the robot can also identify its current location and look up the corresponding module and rack location in case of a fault. A camera can also be mounted on the robot to provide operators with a real-time view of the status of the BESS. Fiducial tags can also be placed on the battery modules to help the robot calibrate its position and identify its charging station. The pole that the robot controller travels on can also be easily set or pushed aside to be less intrusive during BESS maintenance, allowing easy access to the modules.

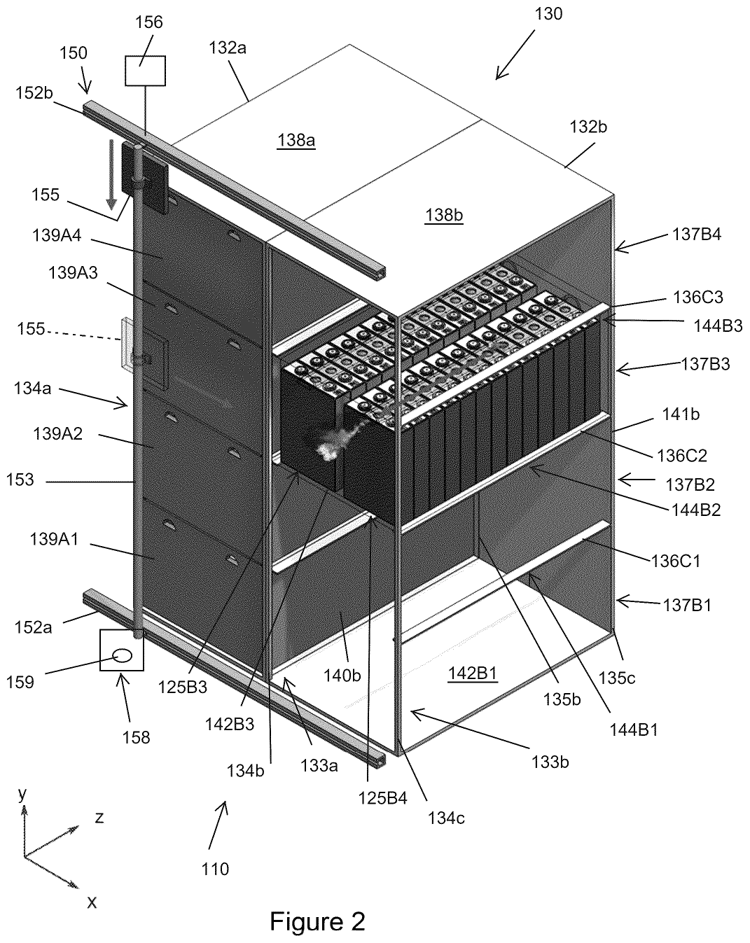

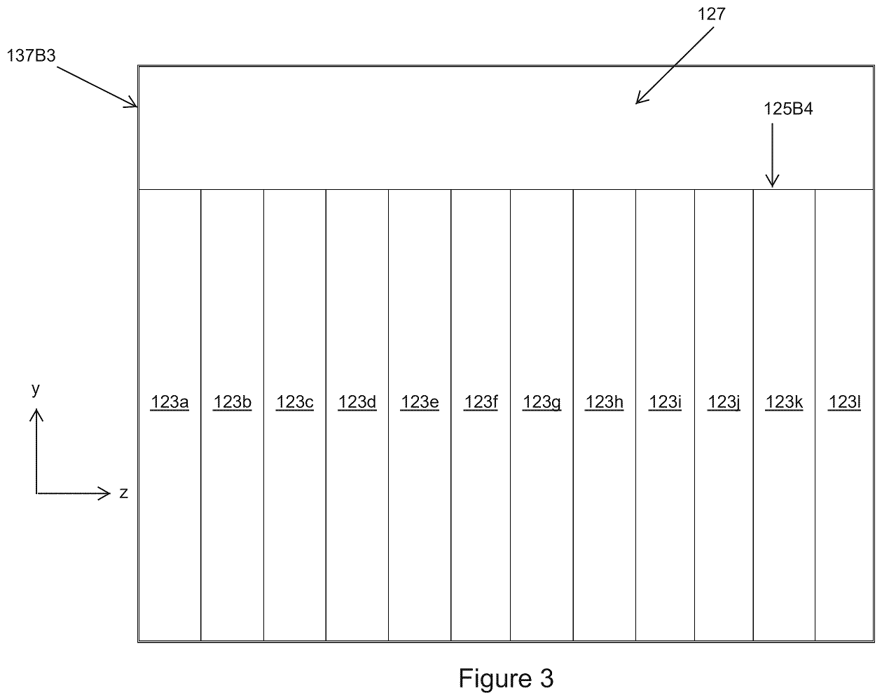

Turning now to FIGS. 2 and 3, there is shown a battery energy storage system 110 according to one embodiment of the present invention. Certain elements of the battery energy storage system 110 have been omitted in FIGS. 2 and 3 for the purposes of illustration and clarity. The battery energy storage system 110 includes a structure 130 dimensioned to receive one or more battery modules, such as battery modules 125B3 and 125B4. Each battery module includes one or more battery cells, such as cells 123a, 123b, 123c, 123d, 123e, 123f, 123g, 123h, 123i, 123j, 123k, 123l in battery module 125B4. In this non-limiting example embodiment, the structure 130 includes two containers 132a, 132b, having frames 133a, 133b, respectively. The frames 133a, 133b are constructed from three front vertical support bars 134a, 134b, 134c, three rear vertical support bars 135a (not shown), 135b, 135c, and twelve horizontal support bars such as 136C1, 136C2, 136C3. This creates four levels in each container 132a, 132b, such as levels 137B1, 137B2, 137B3, 137B4 of container 132b shown in FIG. 2. The structure 130 includes top covers 138a, 138b, and front covers, such as 139A1, 139A2, 139A3, 139A4. The structure 130 includes side walls, such as wall 140b shown in FIG. 2, that partially define the containers 132a, 132b. The structure 130 includes rear walls, such as wall 141b shown in FIG. 2, that partially define the containers 132a, 132b. The structure 130 includes floors, such as floor 142B1 shown in FIG. 2, that partially define the containers 132a, 132b. The frames, horizontal support bars, and floors define six racks, such as racks 144B1, 144B2, 144B3 shown in FIG. 2. It should be appreciated that the battery energy storage system structure can include any number of containers and levels in each container.

The battery energy storage system 110 includes an XY motion system 150 constructed from horizontal support bars 152a, 152b and a vertical support bar 153 to create a gantry system. The XY motion system 150 can be free-standing or can be mounted to a wall or a frame of one or both of the containers 132a, 132b. A drive control mechanism controls motion of the vertical support bar 153 in x directions with respect to attached horizontal support bars 152a, 152b as shown in FIG. 2. A drive control mechanism controls motion of a sensor suite 155 in y directions with respect to vertical support bar 153 as shown in FIG. 2. The drive control mechanisms are in electrical communication with a programmable controller 156 for controlling XY motion of the sensor suite 155 with respect to the battery modules of the battery energy storage system 110. The controller 156 may include a microprocessor under the control of a software program stored in the controller memory. The vertical support bar 153 has a docking position 158 with a power source 159. The sensor suite 155 can include one of, or any combination of, the following: an off-gas detector, a sparker, a fan, a cooling device, and a camera. One or more battery cells 123a-123l of the battery modules can include one of, or any combination of, the following additional sensors: a temperature sensor, a pressure sensor, a current sensor, a voltage sensor, a volume change sensor, a swelling sensor, and a fiducial tag.

Having described the components of the battery energy storage system 110, operation of the non-limiting embodiment of the battery energy storage system 110 can be explained further. The structure 130 of the battery energy storage system 110 of FIG. 2 can be equipped with, for example, sixteen battery modules, wherein each battery module includes one or more battery cells, such as battery cells 123a-123l, as shown in FIG. 2. It should be appreciated that the battery energy storage system can be equipped with any number of battery modules, and each battery module can independently include any number of battery cells.

The sensor suite 155 includes an off-gas detector configured to obtain air

samples adjacent the battery modules. The off-gas detector generates signals indicating whether off-gas is detected in each of the air samples. As shown in FIG. 2, the sensor suite 155 with the off-gas detector is mounted on the vertical support bar 153 of the XY motion system 150. The controller 156 is in electrical communication with the sensor suite 155 with the off-gas detector and the XY motion system 150. The controller 156 is configured to execute a program stored in the controller 156 to: (i) move the sensor suite 155 with the off-gas detector adjacent one of, or any combination of the battery modules, and (ii) receive the signals from the sensor suite 155 with the off-gas detector indicating whether off-gas is detected in each of the air samples. The controller 156 executes the program stored in the controller 156 to control XY motion of the sensor suite 155 with the off-gas detector relative to at least one of the battery modules using the XY motion system 150.

The signals received by the controller 156 can be passed to a thermal runaway detection algorithm in the program stored in the controller 156. The algorithm can be run by a processor of the controller 156. In one embodiment, the controller 156 is in electrical communication with one or more additional sensors, wherein each additional sensor senses a parameter associated with at least one of the battery cells, wherein the additional sensors can be selected from temperature sensors, pressure sensors, current sensors, voltage sensors, volume change sensors, and swelling sensors. The sensor signals from the one or more additional sensors can be passed to the thermal runaway detection algorithm. In one embodiment, the off-gas is associated with a failure of at least one of the battery cells, and the controller executes the program stored in the controller to identify a location of the failure.

In one embodiment, the off-gas detector includes a gas sensor for detecting an off-gas component selected from CO₂, CO, H₂, volatile organic compounds, and combinations thereof. In one embodiment, the off-gas detector includes an environmental sensor for measuring an environmental reading selected from air temperature, pressure, and humidity, and combinations thereof. In one embodiment, a sparker is mounted on the vertical support bar 153 of the XY motion system 150, and the sparker initiates combustion of any off-gas detected. In one embodiment, a fan is mounted on the vertical support bar 153 of the XY motion system 150, and the fan is configured to dilute the off-gas. In one embodiment, a cooling device is mounted on the vertical support bar 153 of the XY motion system 150, and the cooling device is configured to cool down the off-gas. In one embodiment, a camera is mounted on the vertical support bar 153 of the XY motion system 150, and the camera provides a real-time view of at least one of the battery cells.

In one embodiment, the controller 156 executes the program stored in the controller 156 to set one or more adaptive gas detection thresholds that account for environmental conditions from the environmental reading adjacent or in the structure 130. In one embodiment, the controller 156 executes the program stored in the controller 156 to calibrate and validate one or more stationary gas sensors mounted on the structure 130. In one embodiment, the controller 156 executes the program stored in the controller 156 to identify a location of the sensor suite 155 with the off-gas detector using signals received from an encoder. In one embodiment, the controller 156 is in electrical communication with one or more fiducial tags, wherein each fiducial tag is placed on one of the battery modules, and the controller 156 executes the program stored in the controller to identify a location of the sensor suite 155 with the off-gas detector using signals received from the one or more fiducial tags. In one embodiment, the controller 156 executes the program stored in the controller to return the vertical support bar 153 of the XY motion system 150 to the docking position 158 for charging of the power source 159. In one embodiment, the controller 156 executes the program stored in the controller to return the vertical support bar 153 of the XY motion system 150 to the docking position 158 to pick an end-effector with a sparker, return to the “hot spot” to consume the emitted gasses, and manage gas accumulation.

In one embodiment, the controller 156 executes the program stored in the controller to move the sensor suite 155 with the off-gas detector using the XY motion system 150 adjacent at least one of the battery cells based on a state of health diagnostic from the at least one of the battery cells. In one example embodiment, the controller 156 can be in electrical communication with an additional sensor for measuring swelling associated with the at least one of the battery cells; and the controller executes the program stored in the controller to determine the state of health diagnostic of the at least one of the battery cells based on a reading from the additional sensor. Techniques for the generation of battery state of health diagnostics can be found in U.S. Pat. No. 11,623,526 to Stefanopoulou et al., which is incorporated herein by reference. In one embodiment, the controller 156 executes the program stored in the controller 156 to move the sensor suite 155 with the off-gas detector adjacent the at least one of the battery cells in a path based on the state of health diagnostic of the at least one of the battery cells. For example, the controller 156 can move the sensor suite 155 with the off-gas detector adjacent a cell having a state of health below a predetermined threshold for air sampling and for detecting or ruling out a fault in one or more battery cells. In one embodiment, the controller 156 executes the program stored in the controller to move the sensor suite 155 with the off-gas detector adjacent the one or more of the battery cells according to a predetermined time schedule.

In one embodiment, the controller 156 executes the program stored in the controller to determine whether off-gas is detected in each of the air samples by inputting the signals from the sensor suite 155 with the off-gas detector into a trained machine learning model, wherein the trained machine learning model is trained on a plurality of signals from the off-gas detector. The trained machine learning model can be further trained on an additional plurality of signals from the off-gas detector, wherein the additional plurality of signals are used to characterize off-gas venting from the at least one of the battery cells and expected temporal volume, momentum, and concentrations of off-gases from thermal runaway of the at least one of the battery cells. A detailed characterization of early vents' and thermal runaways' expected temporal volume, momentum, and concentrations expands fundamental understanding of the pattern and the risk of thermal propagation.

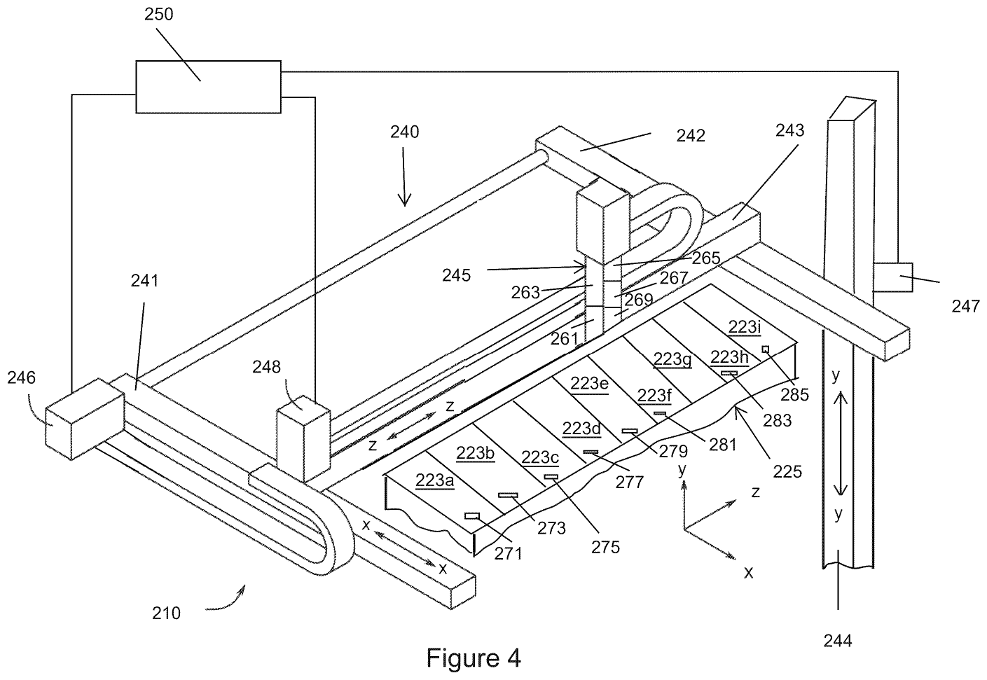

Referring now to FIG. 4, there is shown an XYZ motion system 240 of another embodiment of a battery energy storage system 210. The XYZ motion system 240 has a first support 241, a second support 242, a third support 243, a fourth support 244, a sensor suite 245, and a controller 250. A drive control mechanism 246 controls motion of the third support 243 in directions x-x with respect to attached first support 241 and second support 242 as shown in FIG. 4. A drive control mechanism 247 controls motion of the second support 242 in directions y-y with respect to attached vertical fourth support 244 as shown in FIG. 4. A drive control mechanism 248 controls motion of the sensor suite 245 in directions z-z with respect to the first support 241 and the second support 242 as shown in FIG. 4. The drive control mechanisms 246, 247, and 248 are in electrical communication with the programmable controller 250 for controlling XYZ motion of the sensor suite 245 with respect to battery cells 223a, 223b, 223c, 223d, 223e, 223f, 223g, 223h, 223i of a battery module 225 of the battery energy storage system 210. The sensor suite 245 can include one of, or any combination of, the following: an off-gas detector 261, a sparker 263, a fan 265, a cooling device 267, and a camera 269. One or more battery cells 223a-223i of the battery module 225 can include one of, or any combination of, the following additional sensors: a temperature sensor 271, a pressure sensor 273, a current sensor 275, a voltage sensor 277, a battery condition sensor 279, a volume change sensor 281, a swelling sensor 283, and a fiducial tag 285.

Having described the components of the battery energy storage system 210, operation of the battery energy storage system 210 can be explained further. The controller 250 is in electrical communication with the sensor suite 245 with the off-gas detector 261 and the XYZ motion system 240. The controller 250 is configured to execute a program stored in the controller 250 to: (i) move the sensor suite 245 with the off-gas detector 261 adjacent one of, or any combination of the battery modules, and (ii) receive the signals from the sensor suite 245 with the off-gas detector 261 indicating whether off-gas is detected in each of the air samples. The controller 250 executes the program stored in the controller 250 to control XYZ motion of the sensor suite 245 with the off-gas detector 261 relative to at least one of the battery modules using the XYZ motion system 240.

The signals received by the controller 250 can be passed to a thermal runaway detection algorithm in the program stored in the controller 250. The algorithm can be run by a processor of the controller 250. In one embodiment, the controller 250 is in electrical communication with one or more additional sensors, wherein each additional sensor senses a parameter associated with at least one of the battery cells, wherein the additional sensors can be selected from temperature sensor 271, pressure sensor 273, current sensor 275, voltage sensor 277, a battery condition sensor 279, volume change sensor 281, and swelling sensor 283. The sensor signals from the one or more additional sensors can be passed to the thermal runaway detection algorithm. In one embodiment, the off-gas is associated with a failure of at least one of the battery cells, and the controller 250 executes the program stored in the controller to identify a location of the failure.

In one embodiment, the off-gas detector 261 includes a gas sensor for detecting an off-gas component selected from CO₂, CO, H₂, volatile organic compounds, and combinations thereof. In one embodiment, the off-gas detector 261 includes an environmental sensor for measuring an environmental reading selected from air temperature, pressure, and humidity, and combinations thereof. In one embodiment, the sparker 263 is mounted on the XYZ motion system 240, and the sparker initiates combustion of any off-gas detected. In one embodiment, the fan 265 is mounted on the XYZ motion system 240, and the fan 265 is configured to dilute the off-gas. In one embodiment, the cooling device 267 is mounted on the XYZ motion system 240, and the cooling device 267 is configured to cool down the off-gas. In one embodiment, the camera 269 is mounted on the XYZ motion system 240, and the camera 260 provides a real-time view of at least one of the battery cells.

In one embodiment, the controller 250 executes the program stored in the controller 250 to set one or more adaptive gas detection thresholds that account for environmental conditions adjacent or in the structure 130. In one embodiment, the controller 250 executes the program stored in the controller 250 to calibrate and validate one or more stationary gas sensors mounted on the structure 130. In one embodiment, the controller 250 executes the program stored in the controller 250 to identify a location of the sensor suite 245 with the off-gas detector 261 using signals received from an encoder. In one embodiment, the controller 250 is in electrical communication with one or more fiducial tags 285, wherein each fiducial tag 285 is placed on one of the battery modules, and the controller 250 executes the program stored in the controller to identify a location of the sensor suite 245 with the off-gas detector 261 using signals received from the one or more fiducial tags 285.

In one embodiment, the controller 250 executes the program stored in the controller to move the sensor suite 245 with the off-gas detector using the XYZ motion system 240 adjacent at least one of the battery cells based on a state of health diagnostic from the at least one of the battery cells. For example, the controller can move the sensor suite 245 with the off-gas detector using the XYZ motion system 240 adjacent at least one of the battery cells based on a state of health diagnostic from the at least one of the battery cells indicating a state of health below a predetermined threshold, such as 75%, 50%, or 25%. The controller 250 can be in electrical communication with an additional sensor 283 for measuring swelling associated with the at least one of the battery cells; and the controller 250 executes the program stored in the controller to determine the state of health diagnostic of the at least one of the battery cells based on a reading from the additional sensor 283. Techniques for the generation of battery state of health diagnostics can be found in U.S. Pat. No. 11,623,526 to Stefanopoulou et al., which is incorporated herein by reference. In one embodiment, the controller 250 executes the program stored in the controller 250 to move the sensor suite 245 with the off-gas detector 261 adjacent the at least one of the battery cells in a path based on the state of health diagnostic of the at least one of the battery cells. For example, the controller 250 can move the sensor suite 245 with the off-gas detector 261 adjacent a cell having a state of health below a predetermined threshold for air sampling and for detecting or ruling out a fault in one or more battery cells. In one embodiment, the controller 250 executes the program stored in the controller to move the sensor suite 245 with the off-gas detector 261 adjacent the one or more of the battery cells according to a predetermined time schedule.

In one embodiment, the controller 250 executes the program stored in the controller to determine whether off-gas is detected in each of the air samples by inputting the signals from the sensor suite 245 with the off-gas detector 261 into a trained machine learning model, wherein the trained machine learning model is trained on a plurality of signals from the off-gas detector. The trained machine learning model can be further trained on an additional plurality of signals from the off-gas detector, wherein the additional plurality of signals are used to characterize off-gas venting from the at least one of the battery cells and expected temporal volume, momentum, and concentrations of off-gases from thermal runaway of the at least one of the battery cells. Training can include consideration of: (i) given the duration of the venting event, will the robot come soon enough to the suspected failure location(s) before the gas disperses at the level that the sensor underestimates the event; (ii) what should be the robot's optimum hovering distance or maneuver (velocity, direction) as the robot approaches the hot spot to protect itself and maximize the exposure to the gases; and (iii) will the robot movement mix the gases modifying the fault's signature and location.

In one embodiment, the controller 250 executes the program stored in the controller to move the sensor suite 245 with the off-gas detector 261 above and/or below a rack of the structure 130. Headspace 127 (see FIG. 3) above the battery modules in the structure 130 allows the XYZ motion system 240 to move the sensor suite 245 with the off-gas detector 261 above and/or below a rack of the structure 130. FIG. 4 shows the sensor suite 245 with the off-gas detector 261 above battery module 225 wherein the XYZ motion system 240 can move the sensor suite 245 with the off-gas detector 261 in directions x-x, y-y, and z-z above battery module 225. Thus, the XYZ motion system 240 of the embodiment of FIG. 4 enables XY motion in relation to battery cells of the battery modules, as in the embodiment of FIGS. 2 and 3, and also Z motion in relation to battery cells of the battery modules.

The embodiments of the invention can be used in method according to the invention for detecting or ruling out a fault in one or more battery cells of a battery module in a battery energy storage system. The battery energy storage system can comprise a structure including a container, and the motion system can comprise a gantry system mounted to a wall or a frame of the container. The method comprises: (a) providing an off-gas detector mounted on a support of a motion system, wherein the off-gas detector is configured to obtain air samples adjacent at least one of the battery cells and to generate signals indicating whether off-gas is detected in each of the air samples; (b) moving the off-gas detector adjacent the at least one of the battery cells using the motion system; (c) receiving, in a controller in electrical communication with the off-gas detector, signals from the off-gas detector indicating whether off-gas is detected in each of the air samples; and (d) detecting or ruling out a fault in the at least one of the battery cells based on the signals from the off-gas detector received by the controller. In one embodiment of the method, step (d) comprises passing the signals received by the controller to a thermal runaway detection algorithm in a program stored in the controller to detect or rule out the fault (e.g., thermal runaway). In one embodiment of the method, the off-gas detector includes a gas sensor for detecting an off-gas component selected from CO₂, CO, H₂, volatile organic compounds, and combinations thereof. The off-gas can be associated with the fault of the at least one of the battery cells, and in one embodiment of the method, step (d) comprises identifying a location of the fault. In one embodiment of the method, step (d) further comprises initiating combustion of the off-gas. In one embodiment of the method, step (d) comprises diluting the off-gas.

In one embodiment of the method, step (d) further comprises cooling down the off-gas. In one embodiment of the method, the battery energy storage system comprises a structure including a rack for receiving the battery module, and step (b) comprises moving the off-gas detector above and/or below the rack. In one embodiment of the method, the motion system is an XY motion system, and step (b) comprises moving the off-gas detector in XY motion relative to the battery module. In one embodiment of the method, the motion system is an XYZ motion system, and step (b) comprises moving the off-gas detector in XYZ motion relative to the battery module. In one embodiment of the method, step (d) further comprises setting one or more adaptive gas detection thresholds that account for environmental conditions. In one embodiment of the method, step (d) further comprises calibrating and validating one or more stationary gas sensors mounted on battery energy storage system. In one embodiment of the method, step (b) comprises moving the off-gas detector based on a state of health diagnostic from the at least one of the battery cells. In one embodiment of the method, step (b) comprises moving the off-gas detector in a path based on the state of health diagnostic of the at least one of the battery cells. The system of the invention can manage the complexity of spatially distributed variability of gases due to mixing and stratification by optimizing the robot path planning and adjusting the path depending on a state of health-aware pattern of the cell and module state. Various operating modes and adaptive calibration based on situational awareness and risk, such as periodic sweeps and exploration sprees in a random or structured coverage responding to an alert or guided by emergency responders.

In one embodiment of the method, step (b) comprises moving the off-gas detector adjacent the at least one of the battery cells according to a predetermined time schedule. In one embodiment of the method, step (d) comprises passing the signals received by the controller into a trained machine learning model, the trained machine learning model being trained on a plurality of signals from the off-gas detector. In one embodiment of the method, the trained machine learning model is further trained on an additional plurality of signals from the off-gas detector, the additional plurality of signals being used to characterize off-gas venting from the at least one of the battery cells and expected temporal volume, momentum, and concentrations of off-gases from thermal runaway of the at least one of the battery cells.

### EXAMPLE

The following Example has been presented in order to further illustrate the invention and is not intended to limit the invention in any way. The statements provided in the Example are presented without being bound by theory.

Recent battery energy storage system (BESS) failures highlight the need to detect gases from venting cells as quickly as possible, as well as the vulnerabilities in existing monitoring infrastructure that would alert the occurrence and location of cell venting. Conventional detection strategies, which rely on stationary gas sensors, can fail to identify low-volume gas release from single-cell early stage (first) venting, especially in large-scale BESS that have multiple racks and modules. Suboptimal or improper fixed sensor placement, gas transport effects (e.g., thermal buoyancy), and dilution below detection thresholds further complicate failure detection. These limitations hinder emergency responders' ability to accurately assess explosion and/or toxicity risks.

To address these challenges, we propose integrating a guided mobile gas sensing platform to complement stationary gas sensors. This system will dynamically monitor spatial and temporal gas evolution during early failure stages by deploying a robotic platform equipped with commercial sensors to detect the most commonly emitted gases (CO₂, H₂, CO, electrolyte vapor). The robot will patrol accessible areas or be strategically guided to areas of interest to actively sample “suspicious zones” with high concentrations of vent gases. This target navigation will be informed by advanced state-of-health (SOH) diagnostics derived from electrical and thermal measurements typically available in the Battery Management System (BMS) data.

A major component of our detection algorithm is to recognize how rapidly a fault is propagating to other cells or the time elapsed from the vent initiation. To this end, we first characterize venting gases in terms of composition, quantity, temperature, and time evolution. Most prior work focused on global, post-thermal runaway (TR) gas analysis. However, the combustion of vent gases during TR makes their characterization challenging, leaving first venting behavior poorly understood. To address this gap, we aim to develop a systematic way to trigger gas generation without full thermal runaway by inducing controlled overheating and arresting the heat after first venting occurs. We will apply this method to two form factors: cylindrical (2.6 Ah) and prismatic (32 Ah), focusing on lithium iron phosphate lithium-ion battery cells due to their widespread adoption in grid-scale BESS.

After characterizing single-cell behavior, we will construct a representative BESS rack with cells inside modules to study venting propagation from vented cells to the module venting channels and to the rack headspace where the stationary sensors are typically located. Our gas characterization will then inform models and algorithms that can recognize the various stages of an evolving failure, including the location and the number of cells undergoing slow discharge, venting, and/or the propagation of thermal runaway. This will guide the robotic sensor platform to reach the appropriate venting channel, providing a faster response and better guidance for first responders.

By integrating robotic mobility with diagnostic and prognostic tools, this will not only improve the detection of first venting events, but also enhance situational awareness for emergency response. It enables high-confidence localization of first venting events, estimates the scale of the fault progression, and quantifies the number of cells involved in or propagating in a thermal runaway event, providing actionable data to guide safer and more rapid containment efforts.

Thus, the present invention provides: (i) an improved BESS gas sensing system for providing better information for risk assessment and emergency response, and (ii) improved methods for detecting or ruling out a fault in one or more battery cells of a battery module in a battery energy storage system.

In light of the principles and example embodiments described and illustrated herein, it will be recognized that the example embodiments can be modified in arrangement and detail without departing from such principles. Also, the foregoing discussion has focused on particular embodiments, but other configurations are also contemplated. In particular, even though expressions such as “in one embodiment”, “in another embodiment”, “in certain embodiments”, or the like are used herein, these phrases are meant to generally reference embodiment possibilities, and are not intended to limit the invention to particular embodiment configurations. As used herein, these terms may reference the same or different embodiments that are combinable into other embodiments. As a rule, any embodiment referenced herein is freely combinable with any one or more of the other embodiments referenced herein, and any number of features of different embodiments are combinable with one another, unless indicated otherwise.

Although the invention has been described in considerable detail with reference to certain embodiments, one skilled in the art will appreciate that the present invention can be practiced by other than the described embodiments, which have been presented for purposes of illustration and not of limitation. Therefore, the scope of the appended claims should not be limited to the description of the embodiments contained herein. Various features and advantages of the invention are set forth in the following claims.

1. A battery energy storage system comprising:
a structure dimensioned to receive one or more battery modules, each battery module including one or more battery cells;
an off-gas detector configured to obtain air samples adjacent at least one of the battery cells and to generate signals indicating whether off-gas is detected in each of the air samples, wherein the off-gas detector is mounted on a support of a motion system; and
a controller in electrical communication with the off-gas detector and the motion system, the controller being configured to execute a program stored in the controller to:
(i) move the off-gas detector adjacent the at least one of the battery cells, and (ii) receive the signals from the off-gas detector indicating whether off-gas is detected in each of the air samples.

2. The system of claim 1 wherein:
the structure comprises a container, and
the motion system comprises a gantry system mounted to a wall or a frame of the container.

3. The system of claim 1 wherein:
the signals received by the controller are passed to a thermal runaway detection algorithm in the program stored in the controller.

4. (canceled)

5. The system of claim 1 wherein:
the off-gas is associated with a failure of the at least one of the battery cells, and
the controller executes the program stored in the controller to: (iii) identify a location of the failure.

6. The system of claim 1 wherein:
the off-gas detector includes a gas sensor for detecting an off-gas component selected from CO₂, CO, H₂, volatile organic compounds, and combinations thereof.

7. (canceled)

8. The system of claim 1 further comprising:
a sparker mounted on the support of the motion system, the sparker initiating combustion of the off-gas.

9. The system of claim 1 further comprising:
a fan mounted on the support of the motion system, the fan being configured to dilute the off-gas.

10. The system of claim 1 further comprising:
a cooling device mounted on the support of the motion system, the cooling device being configured to cool down the off-gas.

11. The system of claim 1 wherein:
the structure comprises a rack for receiving the one or more battery modules, and
the controller executes the program stored in the controller to move the off-gas detector above and/or below the rack.

12. The system of claim 1 wherein:
the motion system is an XY motion system, and
the controller executes the program stored in the controller to control XY motion of the off-gas detector relative to at least one of the battery modules.

13. The system of claim 1 wherein:
the motion system is an XYZ motion system, and
the controller executes the program stored in the controller to control XYZ motion of the off-gas detector relative to at least one of the battery modules.

14. The system of claim 1 wherein:
the controller executes the program stored in the controller to set one or more adaptive gas detection thresholds that account for environmental conditions.

15. The system of claim 1 wherein:
the controller executes the program stored in the controller to calibrate and validate one or more stationary gas sensors mounted on the structure.

16. The system of claim 1 wherein:
the controller executes the program stored in the controller to: (iii) identify a location of the off-gas detector using signals received from an encoder.

17. The system of claim 1 further comprising:
a camera mounted on the support of the motion system, the camera providing a real-time view of the at least one of the battery cells.

18. The system of claim 1 wherein:
the controller is in electrical communication with one or more fiducial tags, each fiducial tag being placed on one of the battery modules, and
the controller executes the program stored in the controller to: (iii) identify a location of the off-gas detector using signals received from the one or more fiducial tags.

19. (canceled)

20. The system of claim 1 wherein:
the controller executes the program stored in the controller to move the off-gas detector adjacent the at least one of the battery cells based on a state of health diagnostic from the at least one of the battery cells.

21. (canceled)

22. (canceled)

23. The system of claim 1 wherein:
the controller executes the program stored in the controller to move the off-gas detector adjacent the at least one of the battery cells according to a predetermined time schedule.

24. The system of claim 1 wherein:
the controller executes the program stored in the controller to determine whether off-gas is detected in each of the air samples by inputting the signals from the off-gas detector into a trained machine learning model, the trained machine learning model being trained on a plurality of signals from the off-gas detector.

25. (canceled)

26. A method for detecting or ruling out a fault in one or more battery cells of a battery module in a battery energy storage system, the method comprising:
(a) providing an off-gas detector mounted on a support of a motion system, the off-gas detector being configured to obtain air samples adjacent at least one of the battery cells and to generate signals indicating whether off-gas is detected in each of the air samples;
(b) moving the off-gas detector adjacent the at least one of the battery cells using the motion system;
(c) receiving, in a controller in electrical communication with the off-gas detector, signals from the off-gas detector indicating whether off-gas is detected in each of the air samples; and
(d) detecting or ruling out a fault in the at least one of the battery cells based on the signals from the off-gas detector received by the controller.

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)
